(19) United States
(12) Patent Application Publication
(10) Pub. No.: US 2023/0053841 A1
(43) Pub. Date: Feb. 23, 2023

(54) OBJECT DETECTION SYSTEM AND OBJECT DETECTION METHOD

(71) Applicant: Panasonic Intellectual Property Management Co., Ltd., Osaka (JP)

(72) Inventors: Yusuke YUASA, Kyoto (JP); Shigeru SAITOU, Kyoto (JP); Shinzo KOYAMA, Osaka (JP); Yutaka HIROSE, Kyoto (JP); Akihiro ODAGAWA, Osaka (JP)

(21) Appl. No.: 17/982,104

(22) Filed: Nov. 7, 2022

Related U.S. Application Data
(63) Continuation of application No. PCT/JP2021/020469, filed on May 28, 2021.

(30) Foreign Application Priority Data
Jun. 19, 2020 (JP) 2020-106125

(51) Int. Cl. G01S 17/894; G01S 7/4865

(52) U.S. Cl. CPC G01S 17/894; G01S 7/4865

(57) ABSTRACT

An object detection system includes a light emitter, an optical sensor, a controller, and a signal processor. The controller controls the light emitter and the optical sensor to cause range segment signals to be outputted from the optical sensor for corresponding range segments. The signal processor includes: a target object information generator that includes a plurality of generators (a first generator through a fifth generator) capable of operating in parallel and generates items of target object information indicating features of target objects for the range segments; and storage that stores the items of target object information. The target object information generator compares a past one of the items of target object information stored in the storage with a feature of a current one of the target objects detected by the optical sensor to generate a corresponding one of the items of target object information.

### CROSS REFERENCE TO RELATED APPLICATIONS

This is a continuation application of PCT International Application No. PCT/JP2021/020469 filed on May 28, 2021, designating the United States of America, which is based on and claims priority of Japanese Patent Application No, 2020-106125 filed on Jun. 19, 2020. The entire disclosures of the above-identified applications, including the specifications, drawings and claims are incorporated herein by reference in their entirety.

### FIELD

The present disclosure relates to an object detection system and an object detection method. In particular, the disclosure relates to an object detection system and an object detection method for processing information about the distance to a target object.

### BACKGROUND

Patent Literature (PTL) 1 discloses an image monitor that detects an object that enters an imaging field and a mobile object from a series of image data captured by an imaging device, and records the series of image data including these objects. Such image monitor includes: a photographing means that images a monitored zone and inputs quantized image data; an input image storage means that stores the image data; a reference image storage means that stores a background image of the monitored zone; a difference arithmetic means that outputs a difference image indicating the difference between the input image and a reference image; a mobile object detection means that compares the position of the object with that of the object in one preceding frame, on the basis of the difference image to detect the mobile object, and updates, at the same time, pixels of the areas excluding the mobile object with a value of the input image; and a display means that displays the input image and provides notification about the result of detecting the mobile object.

PTL 2 discloses an information processing device that continuously performs highly accurate tracking. Such information processing device includes: an acquisition part that acquires information in which positions in the vertical, horizontal, and depth directions of an object in a plurality of tame points are associated; a prediction part that predicts the position of the predetermined object in the information currently acquired by the acquisition part, on the basis of the position of the predetermined object in information previously acquired by the acquisition part; and an extraction part that extracts a plurality of objects satisfying a predetermined condition in accordance with the position of the predetermined object from the currently acquired information, and extracts the same object as the predetermined object in the previously acquired information from the plurality of objects in the currently acquired information on the basis of the degree of similarity between an image of each of the plurality of objects and an image of the predetermined object.

### CITATION LIST

### Patent Literature

PTL 1: Japanese Patent No. 3423624
PTL 2: Japanese Unexamined Patent Application Publication No. 2018-88233

### SUMMARY

### Technical Problem

The present disclosure aims to provide an object detection system and an object detection method capable of high-speed object detection.

### Solution to Problem

To achieve the above object, the object detection system according to an aspect of the present disclosure includes: a light emitter that emits light; an optical sensor that receives reflected light that is the light reflected in a distance-measurable area in a target space; a controller that controls the light emitter and the optical sensor; and a signal processor that processes information represented by an electric signal generated in the optical sensor. Here, the controller controls the light emitter and the optical sensor to cause each of range segment signals to be outputted from the optical sensor for a corresponding one of range segments into which the distance-measurable area is segmented, the range segment signal being a signal from a pixel that receives the light among a plurality of pixels included in the optical sensor. The signal processor includes: a target object information generator that includes a plurality of generators capable of operating in parallel and generates items of target object information indicating features of target objects detected in the range segments by the optical sensor, based on the range segment signals outputted from the optical sensor; storage that stores the items of target object information that are generated by the target object information generator and correspond to the range segments; and an outputter that outputs the items of target object information that correspond to the range segments. The target object information generator compares, for each of the range segments, a past one of the items of target object information stored in the storage with a feature of a current one of the target objects detected by the optical sensor to generate a corresponding one of the items of target object information.

To achieve the above object, the object detection method according to an aspect of the present disclosure is an object detection method performed by an object detection system including a light emitter that emits light and an optical sensor that receives reflected light that is the light reflected in a distance-measurable area in a target space. Such object detection method includes: controlling the light emitter and the optical sensor; and processing information represented by an electric signal generated in the optical sensor. In the controlling, the light emitter and the optical sensor are controlled to cause each of range segment signals to be outputted from the optical sensor for a corresponding one of range segments into which the distance-measurable area is segmented, the range segment signal being a signal from a pixel that receives the light among a plurality of pixels included in the optical sensor. The processing includes: generating items of target object information indicating features of target objects detected in the range segments by the optical sensor, based on the range segment signals outputted from the optical sensor, the generating being performed by a plurality of generators capable of operating in parallel; causing storage to store the items of target object information that are generated in the generating and correspond to the range segments; and outputting the items of target object information that correspond to the range segments. In the generating, a past one of the items of target object information stored in the storage is compared with a feature of a current one of the target objects detected by the optical sensor, for each of the range segments, to generate a corresponding one of the items of target object information.

### Advantageous Effects

The object detection system and the object detection method in the present disclosure are capable of high-speed object detection.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing the configuration of an object detection system in one exemplary embodiment.

FIG. 2 is a diagram showing an outline of a method of measuring the distance to each target object performed by the object detection system in the embodiment.

FIG. 3A is a diagram showing the configuration of an information processing system included in the object detection system in the embodiment.

FIG. 3B is a timing chart showing processes performed by the information processing system included in the object detection system in the embodiment.

FIG. 4 is a flowchart showing the flow of processes performed by a target object information generator of the object detection system in the embodiment.

FIG. 5 is a diagram for describing an example of range segment image generation processing performed by the target object information generator of the object detection system in the embodiment.

FIG. 6 is a diagram for describing speed generation processing performed by the target object information generator of the object detection system in the embodiment.

FIG. 7 is a diagram for describing an example of target object information that can be generated by the target object information generator of the object detection system in the embodiment.

FIG. 8 is a diagram for describing an example of changing the settings for distance measurement performed by the target object information generator of the object detection system in the embodiment.

FIG. 9A is a diagram for describing an example image displayed by a presenter of the object detection system in the embodiment,

FIG. 9B is a diagram for describing the correction of the central coordinates of an object, using a luminance image, performed by the target object information generator of the object detection system in the embodiment.

FIG. 9C is a diagram for describing a method, performed by the target object information generator of the object detection system in the embodiment, of calculating the depth range of an object, using range segment signals of a plurality of range segments.

FIG. 10 is a timing chart showing an example order of the processes performed in the object detection system in the embodiment.

FIG. 11 is a diagram for describing an example of distance measurement performed by the target object information generator in a variation of the embodiment.

### DESCRIPTION OF EMBODIMENT

### Embodiment

The following describes in detail the embodiment with reference to the drawings. Note, however, that a more detailed description than is necessary may be omitted. For example, detailed description of a well-known matter or repetitive description of substantially the same configuration may be omitted. This is to prevent the following description from becoming unnecessarily redundant and facilitate the understanding of those skilled in the art.

Also note that the inventors provide the accompanying drawings and the following description for those skilled in the art to fully understand the present disclosure, and thus that these do not intend to limit the subject recited in the claims.

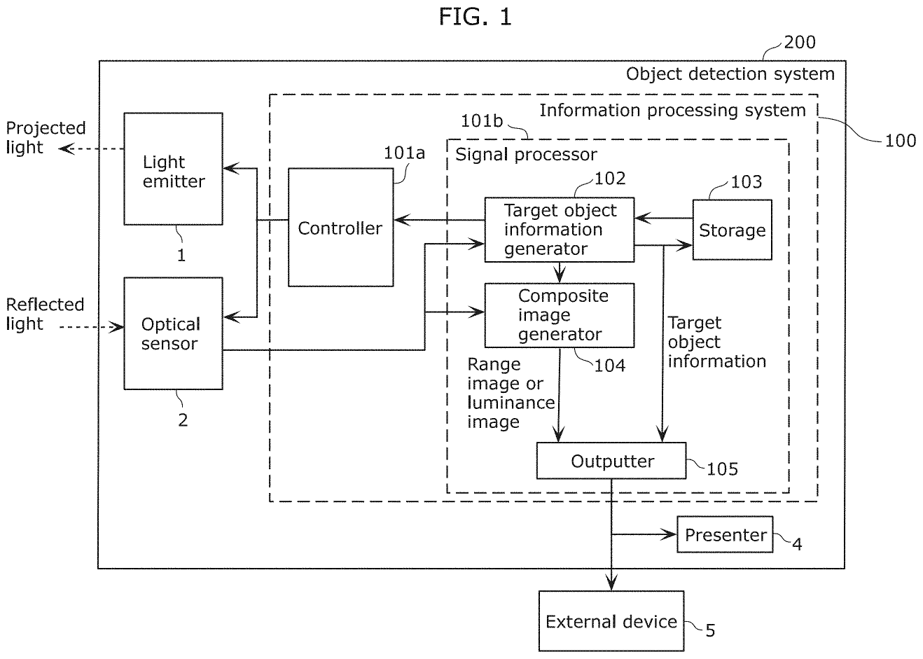

The following describes the embodiment with reference to FIG. 1 through FIG. 11.

### [1. Configuration]

### [1-1. Configuration of Object Detection System]

FIG. 1 is a diagram showing the configuration of object detection system 200 according to the embodiment, Note that FIG. 1 also shows external device 5 that is connected to object detection system 200 via a communication path. As shown in FIG. 1, object detection system 200 includes information processing system 100, light emitter 1, optical sensor 2, and presenter 4. Object detection system 200 is a system that detects an object in each of a plurality of range segments, utilizing direct time of flight (TOF) measurement. Examples of extern& device 5 include a storage device (e.g., a semiconductor memory), a computer device, and a display.

Light emitter 1 includes a light source for emitting measurement light to a target object under the control of controller 101a. The measurement light is pulse light. In distance measurement utilizing TOF, the measurement light may be light of single wavelength. Also, the puke width of the measurement light may be relatively short and the peak intensity of the measurement light may be relatively high. In consideration of the case where object detection system 200 (more strictly, optical sensor 2) is used in an urban area, for example, the wavelength of the measurement light may be in the near-infrared wavelength region to which the spectral sensitivity of the human eye is low and which is less affected by ambient light from sunlight. In the present embodiment, the light source includes, for example, a laser diode, and outputs a puke laser. The intensity of a puke laser outputted from the light source satisfies the standards of class 1 or class 2 of Japanese Industrial Standards (JIS) C 6802, which is the safety standards for laser products. Note that the light source is not limited to having the foregoing configuration. The light source may thus be, for example, a light emitting diode (LED), a vertical cavity surface emitting laser (VCSEL), a halogen lamp, etc. Also, the measurement light may be in a wavelength region different from the near-infrared region.

Optical sensor 2 is a sensor that receives reflected light that is the measurement light reflected in a distance-measurable area in a target space, Optical sensor 2 includes a pixel portion including a plurality of pixels. An avalanche photodiode is disposed in each pixel. Other optical detection elements may also be disposed in the pixels, Each pixel is configured to be switched between exposure mode in which reflected right is received and non-exposure mode in which no reflected right is received, under the control of controller 101a, Optical sensor 2 outputs electric charge that is based on reflected light received by each pixel in exposure mode.

Information processing system 100 includes: controller 101a that controls light emitter 1 and optical sensor 2; and signal processor 101a that processes information represented by an electric signal generated in optical sensor 2. Controller 101a controls light emitter 1 and optical sensor 2 (i.e., performs controlling of the light emitter and the optical sensor) to cause a range segment signal that is a signal from a pixel that has received light to be outputted from optical sensor 2, for each of a plurality of range segments into which the distance-measurable area is segmented, among a plurality of pixels included in optical sensor 2.

Signal processor 101b processes information represented by an electric signal generated in optical sensor 2 (i.e., performs processing of information represented by an electric signal), To do this, signal processor 101b includes: target object information generator 102 including a plurality of generators (first generator through fifth generator) capable of performing processes in parallel and generate items of target object information representing the features of target objects detected by optical sensor 2 in the corresponding range segments, on the basis of the range segment signals outputted from optical sensor 2 (i.e., performs generating of items of target object information); composite image generator 104 that generates a composite image from a plurality of range segment signals that are outputted from optical sensor 2 and correspond to the range segments (i.e., perform generating of a composite image); storage 103 that stores the items of target object information that are generated by object information generator 102 and correspond to the range segments (i.e., performs causing the storage to store the items of target object information); and outputter 105 that outputs the items of target object information that correspond to the range segments and the composite image to external device 5. Target object information generator 102 generates target object information, for each of the plurality of range segments, by comparing past target object information stored in storage 103 with the features of the current target object information detected by optical sensor 2.

In object detection system 200, the emission of measurement light and the light reception, in which an exposure operation of each pixel in sensor 2 is performed, are performed at least once. Each pixel outputs the number of electric signals that is equal to the number of times such pixel receives light in the light reception operation. Non-limiting examples of the number of times light reception operations are performed (the number of times of receiving light) is on the order of 50 times.

### [1-2. Outline of Distance Measurement]

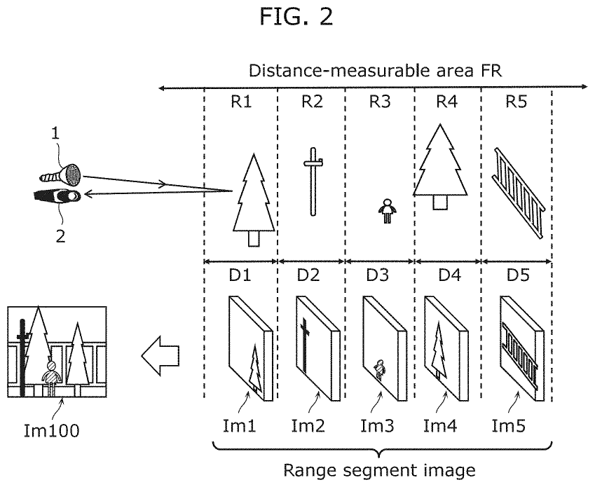

FIG. 2 is a diagram showing an outline of a method of measuring the distance to each target object performed by object detection system 200 according to the embodiment.

As shown in FIG. 1, object detection system 200 measures the distance to a target object, using light that is the measurement light outputted from light emitter 1 and reflected by the target object. Example applications of object detection system 200 include: an in-vehicle object detection system aboard an automobile for detecting an obstacle; a monitoring camera that detects an object, a person, and so forth; and a security camera.

Object detection system 200 measures the distance to each target object that is present in distance-measurable area FR in the target space, Distance-measurable area FR is determined in accordance with the time (set time) from when light emitter 1 emits measurement light to when optical sensor 2 performs the last exposure operation under the control of controller 101a. Non-limiting examples of the range of distance-measurable area FR include several tens of centimeters to several tens of meters. In object detection system 200, distance-measurable area FR may be fixed or set variably. The present description assumes that distance-measurable area FR is variably set.

To be more specific, target object information generator 102 determines whether a target object is present in each of at least one range segment (here, five range segments are present as an example), range segments R1 through R5, included in distance-measurable area FR. For a range segment in which a target object is determined to be present, target object information generator 102 generates target object information that is information about the features of such target object. A plurality of range segments R1 through R5 are segments into which distance-measurable area FR is segmented in accordance with differences in time elapsed after the point in time when emitter 1 emits measurement light. Stated differently, distance-measurable area FR includes a plurality of range segments R1 through R5. The present description assumes that range segments R1 through R5 have the same length. Non-limiting examples of the length of range segments R1 through R5 include several centimeters to several meters. Note that range segments R1 through R5 do not necessarily have to have the same length, and the number of range segments is not limited to a specific number. The number of range segments can be selected typically from 1 through 15. The interval between range segments is also not limited to a specific interval. For example, an interval of several meters may be set between one range segment and an adjacent range segment, and such interval may not be subjected to distance measurement. Also, some range segments may be set to partially overlap with each other. The present description assumes an example case where no interval is set between range segments, and range segments do not overlap with each other.

Controller 101a controls light emitter 1 and optical sensor 2 to cause the pixels in optical sensor 2 to be exposed to light, for example, at a point in time when the time has elapsed that corresponds to twice the distance to the nearest point in the target range segment, among range segments R1 through R5, after light emitter 1 emits measurement light. Controller 101a also controls optical sensor 2 to cause the exposure in the pixels in optical sensor 2 to end (the end of the exposure operation) at a point in time when the time has elapsed that corresponds to twice the distance to the furthest point in such target range segment. As described above, when optical sensor 2 is operated, in the case where a target object is present in a target range segment, light is received in ones of the pixels in optical sensor 2 which are in the region that corresponds to the position of the target object on a plane that is vertical to the optical axis of object detection system 200. With this, it is possible for target object information generator 102 to obtain information about whether a target object is present in the target range segment and about the two-dimensional position of such target object. Also, by assigning the value “1” or “0” to each of the plurality of pixels depending on whether the pixel has received light, it is possible for target object information generator 102 to generate a binary image (range segment image) representing the two-dimensional position where the target object is present in the target range segment.

Also, in the measurement of each range segment, controller 101a may cause the emission of measurement light to be performed and the light reception, in which an exposure operation of each pixel in sensor 2 is performed, to be performed at least twice. In this case, when the number of times each pixel receives light exceeds a predetermined threshold (the number of times of receiving light), target object information generator 102 may determine that a target object is present in the position that corresponds to such pixel. The light receiving operation, when performed at least two of times, can reduce the effect of noise and so forth.

By performing the foregoing operation in each of range segments R1 through R5, it is possible for target object information generator 102 to determine whether a target object is present in the range segment and obtain target object information.

Using an example shown in FIG. 2, the foregoing operation performed by object detection system 200 will be described in more details. In an example shown in FIG. 2, a target object is present in each of range segments R1 through R5. A target object that is a tree is present in range segment R1, a target object that is a power pole is present in range segment R2, a target object that is a person is present in range segment R3, a target object that is a tree is present in range segment R4, and a target object that is a fence is present in range segment R5. For convenience of description, the following assumes that the distance from object detection system 200 to range segment R1 is D0, and the lengths of range segments R1, R2, R3, R4, and R5 are D1, D2, D3, D4, and D5, respectively, Note that the distance from object detection system 200 to the furthest point in range segment R1 is equal to the distance represented by D0+D1. As an example, D0 is assumed to be 0 m. The depth width of distance-measurable area FR is represented by D0+D1+D2+D3+D4+D5.

In object detection system 200, in the case of determining whether a target object is present in range segment R1, for example, the exposure in optical sensor 2 is stopped at a point in time when time (2×(D0+D1)/c) has elapsed after light emitter 1 emits measurement light under the control of controller 101a, where c is the optical speed. As shown in FIG. 2, in range segment R1, a target object that is a tree is present in a position that corresponds to a lower part pixel region among the plurality of pixels in optical sensor 2. For this reason, in optical sensor 2, the number of times light is received in the pixels in the region that corresponds to the position where the person is present exceeds a threshold, whereas the number of times light is received in the other pixels does not exceed the threshold. With this, for range segment R1, it is possible for target object information generator 102 to obtain range segment image Im1 as an image representing the target object that is present in range segment R1.

Similarly, it is possible for target object information generator 102 to obtain range segment images Im2 through Im5 as shown in FIG. 2 for range segments R2 through R5.

Note that, in reality, the tree that is the target object present in range segment R4, for example, is partially hidden by a person that is the target object present in range segment R3 located closer to object detection system 200 than range segment R4. For simplification purposes, however, the tree is illustrated to have an actual tree shape in range segment image Im4 in FIG. 2. The same is applicable to the other range segment images.

Further, composite image generator 104 synthesizes a plurality of range segment images Im1 through Im5 obtained for the respective range segments R1 through R5 to generate, as an example composite image, range image Im100 of distance-measurable area FR. More specifically, among the pixels in each of range segment images Im1 through Im5, composite image generator 104 assigns, to pixels in the region that corresponds to the target object, weights that are different from range segment to range segment (R1 through R5), and superimposes a plurality of range segment images Im1 through Im5 over each other. Through this, range image Im100 as shown in FIG. 2, for example, is generated. Range image Im100 is an example composite image generated by composite image generator 104 and is an image obtained by combining a plurality of range segment images, which are binary images, to which weights are assigned. Note that assignment of weights that are different from range segment to range segment (R1 through R5) is not necessarily essential in combining a plurality of range segment images. Thus, such image synthesis may be performed by assigning the same weight, or by, applying logical OR, for example, on the same pixel positions.

Composite image generator 104 generates a luminance image as a composite image, in addition to range image Im100. Stated differently, composite image generator 104 further adds, to each pixel, an electric signal obtained by performing the exposure operation at least once for each of the plurality of range segments R1 through R5. Through this, for example, a luminous image that represents the luminance of each pixel by 8 bits is generated. The luminance image is another example composite image generated by composite image generator 104, and is an image including information indicating the luminance of each pixel.

Object detection system 200 of the present embodiment is capable of generating range segment images Im1 through Im5, range image Im100, and the luminance image.

Note that object detection system 200 is not necessarily have to generate range segment images Im1 through Im5, and thus simply required to generate information (signal), on the basis of which range segment images Im1 through Im5 can be generated. For example, an image in which information about the number of times of receiving light is held for each pixel may be generated as “information, on the basis of which range segment images Im1 through Im5 can be generated”. The same is applicable to range image Im100 and the luminance image.

### [1-3. Configuration of Information Processing System]

As shown in FIG. 1, information processing system 100 includes controller 101a, signal processor 101b, outputter 105, and presenter 4. Controller 101a and signal processor 101b are implemented by, for example, a computer system that includes at least one processor and at least one memory. Stated differently, the foregoing at least one processor executes at least one program stored in the at least one memory, thereby serving as controller 101a and signal processor 101b. Here, the program is preliminarily recorded in the memory, but may be provided via a telecommunications circuit such as the Internet, or on a non-transitory recording medium, such as a memory card, that stores the program.

Controller 101a is configured to control light emitter 1 and optical sensor 2.

For the control of light emitter 1, controller 101a controls, for example, the timing at which light emitter 1 outputs measurement light from the light source (light emission timing), the pulse width of the measurement light outputted from the light source of light emitter 1, and so forth.

For the control of optical sensor 2, controller 101a controls, for example, the timing at which each pixel in optical sensor 2 enters exposure mode (exposure timing), the duration of exposure, the timing at which an electric signal is readout, and so forth.

Controller 101a controls the light emission timing of light emitter 1 and the timing of at which each operation is performed in optical sensor 2, for example, on the basis of internally stored timings.

Controller 101a sequentially measures the distances of range segments R1 through R5 included in distance-measurable area FR. Stated differently, controller 101a first causes light emitter 1 to emit light and optical sensor 2 to perform exposure for range segment R1 that is closest to object detection system 200, thereby causing optical sensor 2 to generate range segment signal Si1 relating to range segment R1. Next, controller 101a causes light emitter 1 to emit light and optical sensor 2 to perform exposure for range segment R2 that is the second closest to object detection system 200, thereby causing optical sensor 2 to generate range segment signal Si2 relating to range segment R2. For range segments R3 through R5, too, controller 101a causes optical sensor 2 to sequentially generate range segment signals Si3 through Si5. Controller 101a repeatedly causes optical sensor 2 to generate range segment signals Si1 through Si5 as described above.

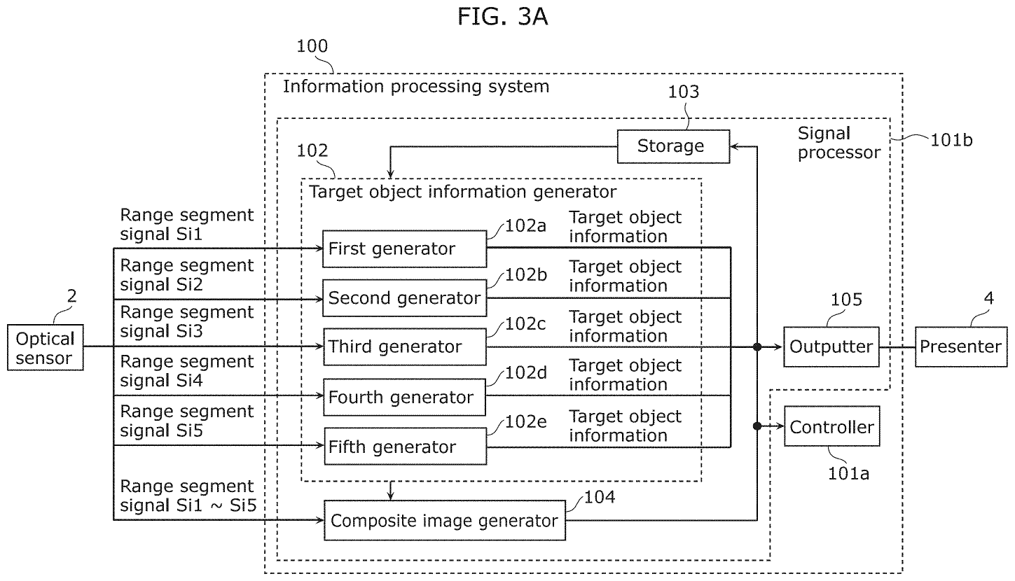

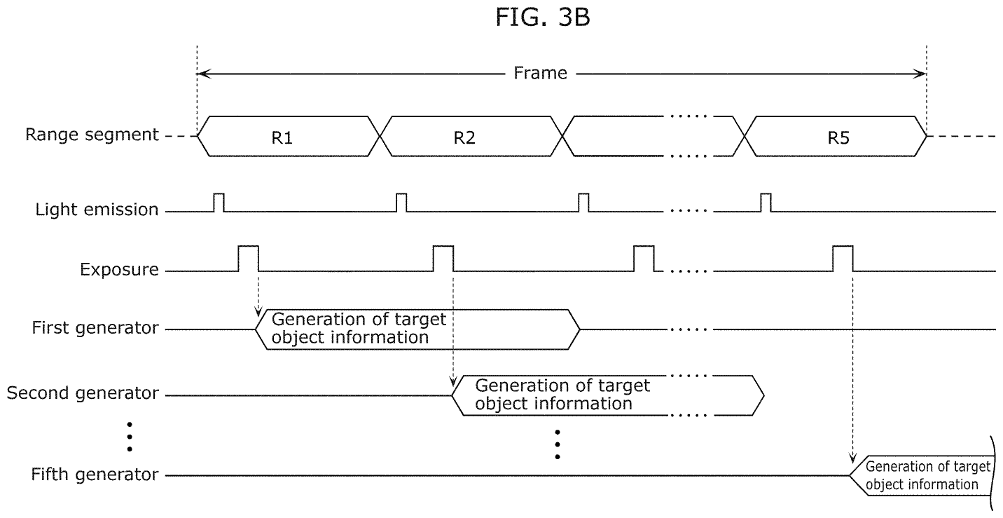

Signal processor 101b receives an electric signal outputted from optical sensor 2. The electric signal includes any one of range segment signals Si1 through Si5. The electric signal received by signal processor 101b is processed by signal processor 101b. FIG. 3A is a diagram showing the configuration of information processing system 100 included in object detection system 200 in the embodiment, Note that FIG. 2 also shows optical sensor 2 and presenter 4 that are located outside of information processing system 100. Information processing system 100 includes controller 101a and signal processor 101b (target object information generator 102, composite image generator 104, storage 103, and outputter 105).

Target object information generator 102 generates items of target object information which are items of information about the features of target objects that are present in the respective range segments R1 through R5, on the basis of the range segment signals relating to the target range segments, among the electric signals generated in optical sensor 2.

Target object information generator 102 includes, for example, the number of generators that corresponds to, for example, the number of range segments (here, five generators) that are capable of operating in parallel (first generator 102a through fifth generator 102e), First generator 102a receives range segment signal Si1 from optical sensor 2. First generator 102a generates target object information about a target object that is present in range segment R1, on the basis of range segment signal Si1, which is an electric signal relating to range segment R1, Similarly, second generator 102b generates target object information about a target object that is present in range segment R2, on the basis of range segment signal Sit, which is an electric signal relating to range segment R2. Third generator 102c generates target object information about a target object that is present in range segment R3, on the basis of range segment signal Si3, which is an electric signal relating to range segment R3. Fourth generator 102d generates target object information about a target object that is present in range segment R4, on the basis of range segment signal Si4, which is an electric signal relating to range segment R4. Fifth generator 102e generates target object information about a target object that is present in range segment R5, on the basis of range segment signal Si5, which is an electric signal relating to range segment R5.

Note that for easier understanding of the description only, a plurality of range segment signals Si1 through Si5 are inputted to target object information generator 102 via different paths and processed by different elements in target object information generator 102 (first generator 102a through fifth generator 102e). However, this is a mere example, and thus range segment signals Si1 through Si5 may be inputted to target object information generator 102 via the same path and processed by the same element.

### [2. Operation]

The following describes an operation performed by object detection system 200 in the present embodiment with the foregoing configuration.

### [2-1. Operation of Information Processing System]

FIG. 3B is a timing chart showing processes performed by information processing system 100 included in object detection system 200 in the present embodiment. The timing chart here shows an example of parallel operations performed by first generator 102a through fifth generator 102e, In FIG. 3B, “range segment” indicates the arrangement of five subframes (range segments R1 through R5) included in each frame, “light emission” indicates the timing at which light emitter 1 emits measurement light, “exposure” indicates the period during which optical sensor 2 receives reflected light, and each of “first generator” through “fifth generator” indicates a processing period during which first generator 102a through fifth generator 102e each generate target object information. FIG. 3B shows an example case where target object information is generated every time a set of light emission and exposure is performed.

As shown in FIG. 3B, in the subframe of range segment R1, light emission and exposure for range segment R1 are performed, after which first generator 102a starts generating target object information for range segment Rio Subsequently, in the subframe of range segment R2, light emission and exposure for range segment R2 are performed, after which second generator 102b starts generating target object information for range segment R2. Thereafter, processes are sequentially performed in the same manner for the subframes of range segment R3, range segment R4, and range segment R5.

Each of first generator 102a through fifth generator 102e starts the process thereof immediately upon receipt of the signal (range segment signal), without waiting for the other generators receiving signals (range segment signals) and completing their processes. Stated differently, first generator 102a through fifth generator 102e operate in parallel. First generator 102a through fifth generator 102e capable of operating in parallel achieve high-speed generation of items of target object information that correspond to the five range segments.

Note that the processes of first generator 102a through fifth generator 102e partially overlap in time, but whether such processes temporally overlap depends on processing load and thus does not necessarily have to temporally overlap. Depending on processing load, for example, the processes of first generator 102a through fifth generator 102e may be completed within the subframes of the corresponding range segments,

### [2-2. Operation of Target Object Information Generator]

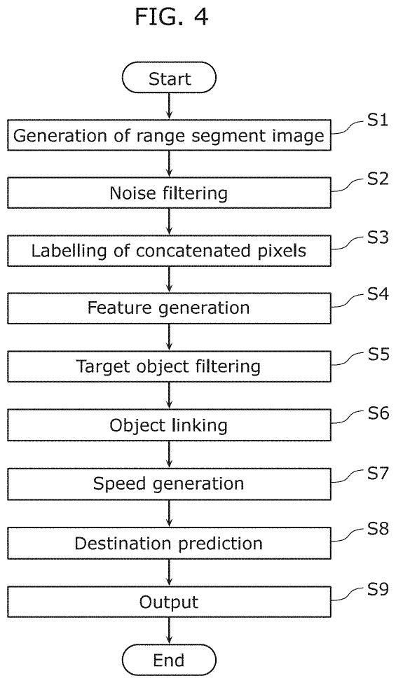

The following describes a method of generating target object information performed by target object information generator 102 of object detection system 200 in the present embodiment. FIG. 4 is a flowchart of processes performed by target object information generator 102 of object detection system 200 in the present embodiment.

Note that following description focuses on the operation relating to range segment R3 in FIG. 2, but the same is applicable to the operations for the other range segments.

First, third generator 102c of target object information generator 102 receives, from optical sensor 2, range segment signal Si3 relating to target range segment R3, among the plurality of range segments R1 through R5. Third generator 102c then performs range segment image generation processing on the received range segment signal Si3, using reference image Im101 that is preliminarily obtained and stored in storage 103 (S1 in FIG. 4).

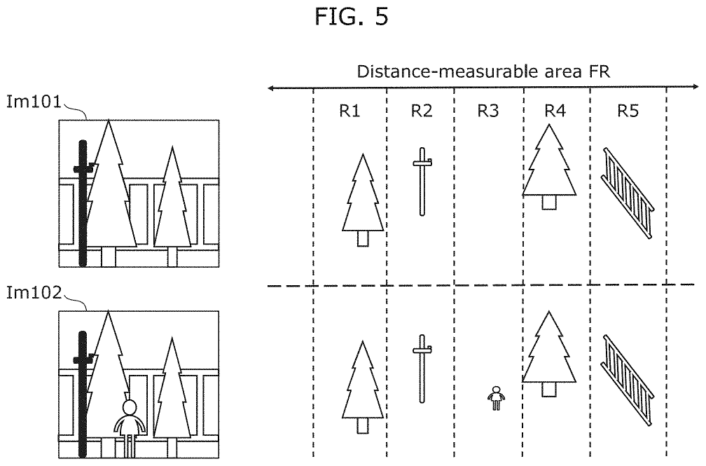

FIG. 5 is a diagram for describing an example of the range segment image generation processing performed by target object information generator 102 of object detection system 200 in the present embodiment. FIG. 5 shows an example of reference image Im101 (upper image in FIG. 5) and range image Im102 (bottom image in FIG. 5). Reference image Im101 (upper image in FIG. 5) is a range image preliminarily obtained by object detection system 200 and stored in storage 103. Range image Im102 (bottom image in FIG. 5) represents range segment signals Sit through Si5 inputted to target object information generator 102. In the range segment image generation processing in such an example case, when determining that a target object is present in the received range segment signal Si3 that is equivalent to a target object included in reference image Im101 at a distance that is equivalent to the distance of such target object in reference image Im101, third generator 102c rewrites position information with information indicating that no target object is present. Through the above process, it is possible to focus only on an object, among the target objects included in range segment signal Si3, other than the target objects included in reference image Im101. In an example of the bottom image in FIG. 5 (range image Im102) that is based on an example of the upper image in FIG. 5 (reference image Im101), a person is not present in range segment R3 when reference image Im101 is obtained. As such, when performing the foregoing range segment image generation processing, third generator 102c generates a signal derived from a person as range segment image Im3 (generates an image in which “1” is stored in the region of the person). As the other range segment images Im1, Im2, Im4, and Im5, no signal derived from the respective target objects are to be generated (images in which “0” is stored in all regions are generated), As in the foregoing manner, target object information generator 102 compares the range segment signal relating to the range segment corresponding to reference image Im101 stored in storage 103 with reference image Im101, thereby generating a range segment image representing the difference therebetween as one item of target object information.

Note, however, that the processing of generating reference image Im101 and the range segment image is not limited to the foregoing method. Also, reference image Im101 may remain unchanged or may be updated while object detection system 200 is in operation. For example, reference image Im101 may be constantly updated with range segment signal Si3 of the one preceding frame. Third generator 102c calculates an optical flow in the range segment image generation processing, determines the amount of movement by which the target object included in reference image Im101 has moved in the current range segment signal Si3. When the amount of movement of the target object exceeds a threshold, third generator 102c may determine that the target object is present and generate a range segment image.

The range segment image generated in the foregoing processing is a binary image in which the value “1” is assigned to a pixel in the region where the target object is present and the value “0” is assigned to a pixel in the region where no target object is present.

Here, third generator 102c may perform noise filtering that is performed in general image processing. Third generator 102c may apply, for example, morphological operation or median filter (S2 in FIG. 4), This reduces noise, and thus results in possible decrease in later processing time.

Also, third generator 102c may encode the range segment image, using a method capable of reducing data amount. Third generator 102c may compress the range segment image, using, for example, run-length encoding.

Subsequently, third generator 102c performs labelling processing (S3 in FIG. 4). In the labelling processing, when adjacent pixels assigned “1” are concatenated, such block of concatenated pixels is determined to be a single object. Labels different from object to object are assigned. When no pixel assigned “1” is present, it is determined that no target object is present in a target range segment.

After the labeling processing, third generator 102c performs feature generation processing (S4 in FIG. 4), In the feature generation processing, the features of the target object are generated on the basis of the region including the concatenated pixels determined to correspond to a single target object. The features are not limited to specific types, but the present description uses, as an example, the following types: a label assigned; information indicating a range segment; the area of a target object; the boundary length of the target object; the first-order moment; the center of gravity; and the position of the center of gravity in a world coordinate system. The world coordinate system is a three-dimensional orthogonal coordinate system in a virtual space that is equivalent to the target space. Information indicating the position of the center of gravity of the target object in the world coordinate system is an example of the target object position information relating to the position of the target object in a three-dimensional space.

After the feature generation processing, third generator 102c performs target object filtering processing (S5 in FIG. 4). In the target object filtering processing, a target object that does not satisfy a specified condition is deleted, with reference to the features of each target object. The specified condition is not limited to a specific condition, but the present description assumes, for example, that the area (the number of pixels) of a target object is 100 pixels or greater. The foregoing target object filtering processing deletes objects other than the object of interest thereby resulting in possible decrease in later processing time.

Subsequently, third generator 102c performs object liking processing, utilizing past target object information stored in storage 103 (S6 in FIG. 4). In the object linking processing, a similarity ratio is defined, for each of the range segments, in a manner that a value is greater when the current target object is similar to a past target object to a greater extent. One of the past target objects that has the highest similarity ratio is determined to be the same target object as the current target object, and these target objects are linked with each other. In so doing, the label of such past target object to be linked is added to the features of the current target object as a linker that enables a later search for the past target object. Of the past target objects, a target object that is subjected to similarity ratio calculation and selected as a candidate to be linked with the current target object is typically a target object in the one preceding frame, but a target object in a frame that is two frames or more preceding the current frame may be selected as a candidate. A similarity ratio is defined as, but not limited to, a function contributed by the distance between the centers of gravity, the first-order moment, and the area. When no past target object to be linked is present, a specific value indicating the absence of a target object to be linked is added as one item of the features. When no past target object to be linked is present, the label of the current target object per se may be added, for example, as a linker serving as an item of the features.

Subsequently, third generator 102c performs speed generation processing of generating a moving speed of the target object (S7 in FIG. 4). Having performed the foregoing object linking processing, third generator 102c is able to track back to the past target object linked with the current target object. Also, such past target object tracked back also stores a linker that enables third generator 102c to track back to a further past target object. As such, it is possible to track back to the time at which the target object first appeared in distance-measurable area FR, In the speed generation processing, third generator 102c tracks back, for example, to the same target object in the preceding N seconds. With reference to the target object position information in each time, third generator 102c calculates the moved distance from the movement trajectory of the center of gravity in the world coordinate system up until the present time, calculates the speed by dividing the moved distance by the time elapsed (N seconds), and adds the resulting speed as one item of the features. In the foregoing manner, target object information generator 102 (here, third generator 102c) generates target object position information relating to the position of the target object in the three-dimensional space, using the range segment signals of the plurality of range segments, and calculates the moving speed of the target object, using the target object position information of the past target object that is the same as the current target object.

The number of frames to track back for speed calculation is defined as, but not limited to, the preceding N frames. In the case where the frame rate at which third generator 102c generates range segment images is variable and the number of frames to track back is defined as the preceding N frames, for example, the number of frames to track back for speed calculation is fixed. This can reduce the effect of errors in the calculation of the position of the center of gravity which is an effect caused by noise that does not depend on the frame rate. Also, the method of speed calculation is not limited to a specific method, and thus may be calculated from the direct distance between the position of the center of gravity in the world coordinate system in the preceding N seconds and the position of the current center of gravity in the world coordinate system.

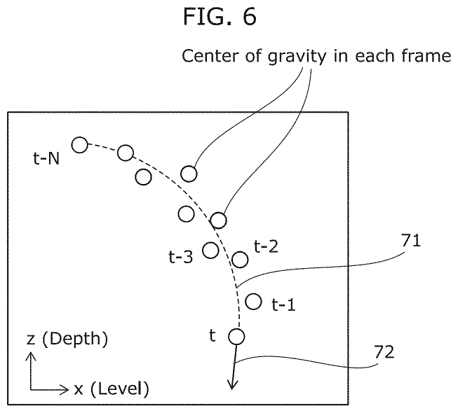

In the speed generation processing, the moving direction of the target object is estimated. FIG. 6 is a diagram for describing an example method of generating the moving direction of a target object performed by target object information generator 102 (here, third generator 102c) of object detection system 200 in the present embodiment. The method of estimating the moving direction is not limited to a specific method, but the present description uses a method of utilizing an arc approximating the trajectory of the target object in the world coordinate system. When utilizing the movement path of the target object for the duration of N seconds, for example, a collection of the centers of gravity of the target object during the period from N seconds before until the present time is used. A principal component analysis is performed on a matrix that stores, in each row, the coordinates of the center of gravity of the target object, and a plane in which the third principal component vector serves as the normal line is assumed to be a plane that well applies to the trajectory of the center of gravity. Then, on the foregoing plane, the point located at the equal distance from the centers of gravity of the preceding N seconds, the preceding N/2 seconds, and the present time is assumed to be a virtual center of rotation of the trajectory of the center of gravity. Here, the position of the center of gravity in the preceding N/2 seconds is updated by the mean value of the positions of the centers of gravity of the preceding N/2-1 seconds, the preceding N/2 seconds, and the preceding N/2+1 second. The target object is assumed to move in an arc for N seconds around the foregoing center of rotation. The moving direction of the target object is assumed to be a direction that is along the tangential line of arc 71 at the current position of the center of gravity and that is away from the position of the center of gravity of the target object in the preceding N seconds. Arc 71 here is an arc, the center of which is the foregoing center of rotation and which passes through the current position of the center of gravity. By approximating the moving trajectory of the target object by a simple curve as in the foregoing manner, it is possible for errors of speed vector 72 to be less affected by the errors of the position of the center of gravity that occur due to noise, etc. As described above, target object information generator 102 (here, third generator 102c) approximates, by a curve, the past movement trajectory of the target object that is the same as the current target object, thereby calculating the moving speed of the target object. Note that a feature used in the method of calculating the foregoing speed vector 72 is not limited to the center of gravity, and thus other features may be used relating to the position of the target object in the world coordinate system, such as the top left point of a circumscribing rectangle provided to the target object.

Third generator 102c adds, to the features, the speed and the moving direction of the target object as speed vector 72 of the target object.

Subsequently, third generator 102c performs destination prediction processing on the basis of the speed of the target object (S8 in FIG. 4). Having performed the speed generation processing, third generator 102c is able to predict the position to which the target object is to move in the near future. The destination prediction processing is not limited to a specific method. To predict a destination to be reached N seconds later, for example, the target object is predicted to linearly move in the foregoing moving direction as much as the distance determined by multiplying the foregoing speed by N. The predicted destination position obtained by the foregoing destination prediction processing is added as one item of the features. As described above, target object information generator 102 (here, third generator 102c) generates a predicted future position of the target object from the moving speed of the target object.

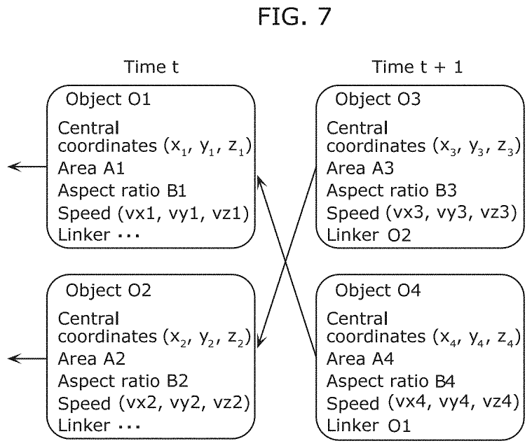

FIG. 7 is a diagram showing an example of target object information that can be generated by target object information generator 102 (here, third generator 102c) of object detection system 200 in the present embodiment. The target object information shown in FIG. 7 includes various features (central coordinates, area, aspect ratio, speed, and linker) relating to two objects O1 and O2 detected at time t and two objects O3 and O4 detected at time t+1. In this example, a linker, which is one of the features of object O3 detected at time t+1, indicates object 2 detected at time t. It is thus possible to know that object O2 and object O3 detected at different times are determined to be the same target object. Similarly, a linker, which is one of the features of object O4 detected at time t+1, indicates object O1 detected at time t. It is thus possible to know that object O1 and object O4 detected at different times are determined to be the same target object. As described above, the target object information includes tracking information used to track the same target object.

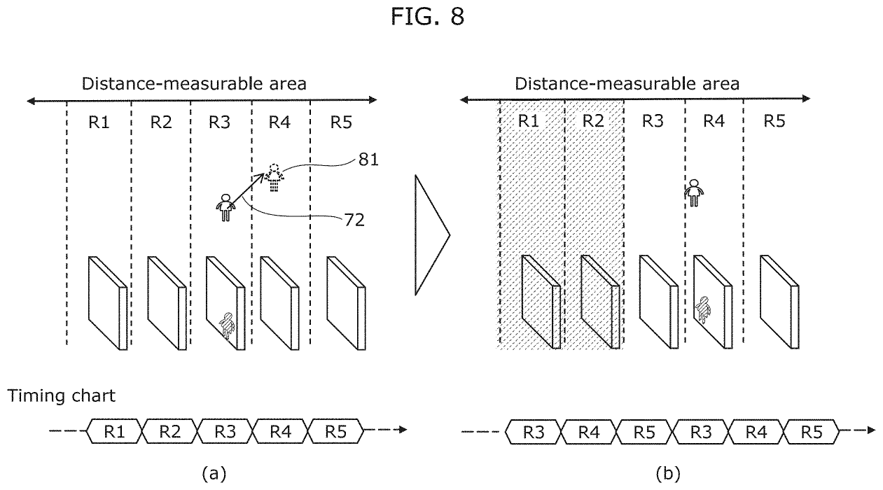

FIG. 8 is a diagram for describing an example of changing the settings for distance measurement performed by target object information generator 102 of object detection system 200 in the present embodiment. Stated differently, FIG. 8 is a diagram for describing an example method of changing the settings stored in controller 101a, on the basis of target object information. After the foregoing destination prediction processing, target object information generator 102 extracts a range segment that includes predicted position 81 of the destination, and changes the settings stored in controller 101a so that only three range segments, the extracted range segment and its previous and subsequent range segments, are to be subjected to distance measurement. In an example shown in FIG. 2, when predicted position 81 of the destination of the person detected in range segment R3 is included in range segment R4 ((a) in FIG. 8), for example, controller 101a controls the light emission timing and the exposure timing to subject only range segments R3 through R5 to distance measurement from the subsequent frame onward, ignoring range segments R1 and R2 ((b) in FIG. 8), in accordance with the foregoing settings change. After this, when the predicted position 81 of the destination of such person is in range segment R3, for example, controller 101a changes the range of distance measurement to range segments R2 through R4, Then, under the control of controller 101a, target object information generator 102 generates target object information only for the range segments after the change. As described above, controller 101a changes the control signals to send to light emitter 1 and optical sensor 2 to cause the number of range segments and the range segments to be subjected to target object information generation to be changed. To be more specific, among a plurality of range segments, controller 101a changes the control signals to send to light emitter 1 and optical sensor 2 to cause range segment signals that correspond to the range segments not including the predicted position of the target object (range segment signals of range segments R1 and R2 in (b) in FIG. 8) not to be outputted from optical sensor 2.

As described above, it is possible to shorten the target object detection processing by limiting the range of distance measurement, on the basis of the features of the detected target object. Note that the features used to change the range of distance measurement are not limited to specific features, and thus a method may be used, for example, that measures the distances of the range segments including the current position of the center of gravity and its previous and subsequent range segments. Also, the number of range segments to be subjected to distance measurement after changing the range of distance measurement is not limited to a specific number.

Finally, outputter 105 outputs, to presenter 4 or external device 5, the features of the target objects as the items of target object information (59 in FIG. 4). In so doing, outputter 105 sequentially outputs the items of target object information generated as a result of the processing performed by target object information generator 102 (more specifically, each of first generator 102a through fifth generator 102e), without waiting for the completion of the measurements of all of the range segments. Outputter 105 may output not only the items of target object information, but also, for example, the luminance image, the range image, or the range segment images. Outputter 105 may output information in the form of a wireless signal.

Presenter 4 presents the information outputted from outputter 105 in a visible form. Presenter 4 may include, for example, a two-dimensional display such as a liquid crystal display and an organic electroluminescence display. Presenter 4 may include a three-dimensional display for displaying a range image in a three-dimensional form.

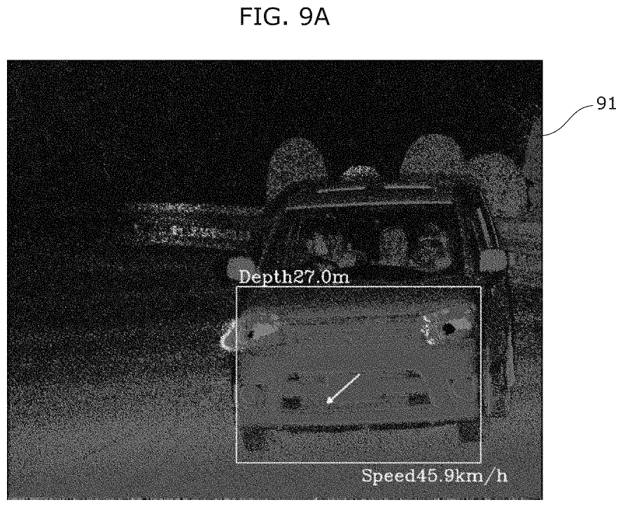

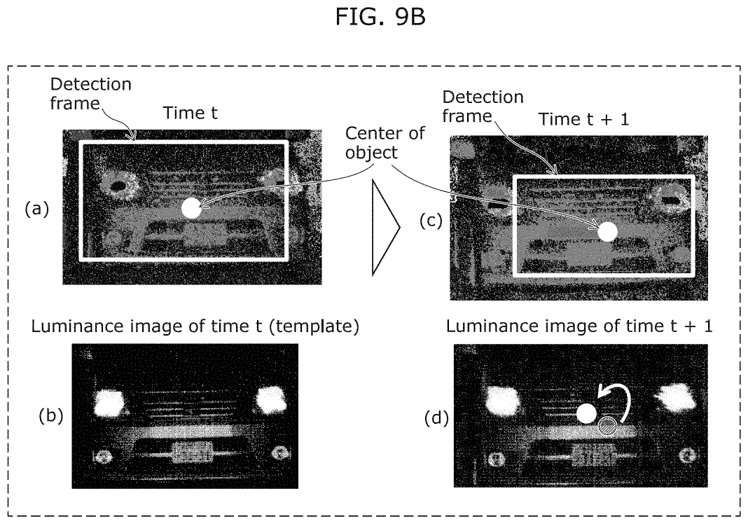

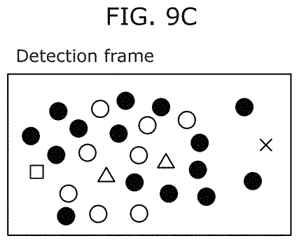

FIG. 9A shows an example of image 91 that is displayed by presenter 4 of object detection system 200 in the present embodiment. The vehicle, which is a mobile object shown in the screen, is displayed with a rectangle (detection frame) indicating that the vehicle is detected. The depth range (“Depth 27.0 m”), the speed (“Speed 45.9 Km/h”) and the direction of the speed vector (arrow in the diagram) that are included in the target object information are also shown.

In calculating the depth range, the speed, and the speed vector of the object detected in the foregoing manner, target object information generator 102 uses a luminance image, which is one of the composite images, to correct the central coordinates of the object, which is one item of the target object information. FIG. 9B is a diagram for describing the correction of the central coordinates of the object, using a luminance image, performed by target object information generator 102, (a) in FIG. 96 shows an example frame (“detection frame”) of the object detected at time t by target object information generator 102, (b) in FIG. 96 shows an example luminance image generated at time t by composite image generator 104, (c) in FIG. 96 shows an example frame (“detection frame”) of the same object detected at time t+1 by target object information generator 102, and (d) in FIG. 9B shows an example correction of the central coordinates of the object performed at time t+1 by target object information generator 102.

At time t, as shown in (a) in FIG. 96, target object information generator 102 identifies the rectangle that encloses the detected object as a detection frame in a certain range segment image. Target object information generator 102 then identifies the center of the detection frame as the central coordinates of the detected object (“center of object”). At time t+1, as shown in (c) in FIG. 96, target object information generator 102 identifies the rectangle that encloses the same object as the object detected at time t as a detection frame in the foregoing range segment image or another range segment image. Target object information generator 102 then identifies the center of the detection frame as tentative central coordinates of the object (“center of object”). Subsequently, target object information generator 102 uses the luminance image of the object at time t as a template (i.e., reference image) to calculate the amount of coordinate shift of the object in the range segment image at time t+1, and shifts the tentative central coordinates in the opposite direction as much as the calculated amount of coordinate shift. Through this, the central coordinates of the object are corrected, using the luminance image with high accuracy, thereby achieving highly accurate identification of the central coordinates of the object, compared to the case where only a range segment image is used. The central coordinates of the object identified in the foregoing manner are used to calculate the depth range, the speed, and the speed vector of the object.

Note that a feature to be corrected is not limited to the central coordinates of the object, and thus the following, for example, may be corrected: the circumscribing rectangle of the object per se; the position of a specific point such as the right top corner point of the circumscribing rectangle; or the position of the silhouette of the object.

Also, in calculating the depth range of the detected object, target object information generator 102 uses range segment signals (or range segment images) of a plurality of range segments to correct the depth range of the object, which is one item of the target object information (stated differently, target object information generator 102 calculates the depth range with high accuracy). FIG. 9C is a diagram for describing the method, performed by target object information generator 102, of calculating the depth range of the object, using the range segment signals of a plurality of range segments. Here, an object formed of a group of points detected in the respective five range segments is shown inside of a detection frame. For example, 8 white circles are points detected in a range segment of 1.5 m, 15 black circles are points detected in a range segment of 3.0 m, 2 triangles are points detected in a range segment of 4.5 m, 1 square is a point detected in a range segment of 21.0 m, and 1 cross is a point detected in a range segment of 22.5 m. In such a case, target object information generator 102 identifies, as the depth range of the object inside of the detection frame, an average distance obtained by weighting each of the distances of the group of points by the number of the points, i.e., (8×1.5 m+15×3.0 m+2×4.5 m+1×21.0 m+1×22.5 m)/(8+15+2+1+1)≈4.05 m. With this, the distance to the object is calculated using the range segment signals of the plurality of range segments, thus enabling a highly accurate calculation of a real distance that takes into consideration the depth of the object, compared to the case where only one range segment signal is used. Note that the range segment signals to be used may be a plurality of range segment images that have been processed by target object information generator 102. Also, the target object information may be corrected, using some or all part of the range image generated by composite image generator 104 as a composite image.

Note that the method of calculating the depth range of the object is not limited to a specific method. For example, a weighted mean may be calculated in a manner that the largest weight is assigned to the range segment in which the largest number of points have been detected. In an example shown in FIG. 9C, for example, with respect to the range segment of 3.0 m in which the largest number points have been detected, a weighted mean is calculated as the depth range of the object in a manner that a weight of ½ is assigned as a range segment is spaced apart by 1.5 m, i.e., (8×1.5 m/2+15×3.0 m+2×4.5 m/2+1×21.0 m/4096+1×22.5 m/8192)/(8+15+2+1+1)≈2.06 m. The method using the weighed mean can be effective for correctly calculating the depth range when noise is included in the group of points that correspond to the target object. In the foregoing example shown in FIG. 9C, the number of points detected in the range segment of 1.5 m is the second largest to the range segment of 3.0 m. As such, points detected in the range segments of 21.0 m and 22.5 m can possibly be noise. For this reason, it is most probable to determine that the depth range is between 1.5 m and 3.0 m.

As described above, according to object detection system 200 of the present embodiment, generation of target object information that is related to a target object present in each of at least one range segment and includes time-dependent features is performed and tracking of a target object is performed, on the basis of the range segment signal relating to the target range segment.

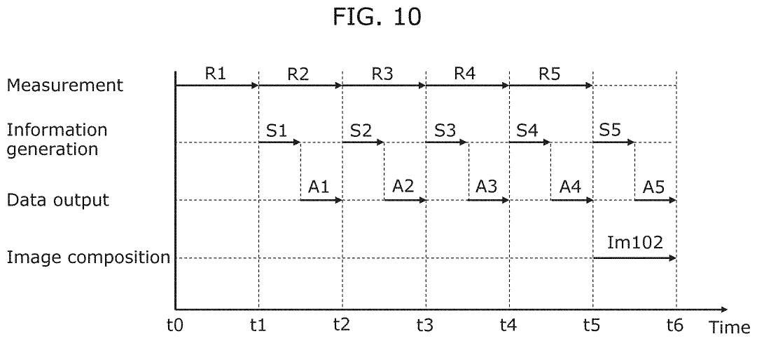

FIG. 10 is a timing chart showing an example order of the processes performed in object detection system 200 in the present embodiment, More specifically, FIG. 10 shows an outline of the temporal relation among: the operation of receiving light performed by optical sensor 2 (“measurement”); the operation of generating target object information performed by each of first generator 102a through fifth generator 102e (“information generation”); the operation of outputting target objects performed by outputter 105 (“data output”); and the operation of generating a range image performed by composite image generator 104 (“image composition”). To be more specific, in FIG. 10, the stage of “measurement” indicates a range segment, among range segments R1 through R5, in which optical sensor 2 performs distance measurement. The stage of “information generation” indicates the timing at which target object information generator 102 processes a range segment signal, among range segment signals Sit through 5i5, to generate target object information. The stage of “data output” indicates the timing at which outputter 105 outputs target object information, among the items of target object information. The stage of “image composition” indicates the timing at which composite image generator 104 generates range image Im102. In FIG. 10, the starting point of the arrow indicates the time point of starting the process and the end point of the arrow indicates the time point of ending the process in each of the stages.

As described above, the range segment signals are processed by first generator 102a through fifth generator 102e and the corresponding items of target object information are generated, without waiting for the other range segment signals to be processed. This can reduce the processing time. Note that in FIG. 10, first generator 102a through fifth generator 102e perform the processes sequentially (i.e., in different time slots), but when the processing load of “information generation” is large, for example, first generator 102a through fifth generator 102e may perform the processes in a temporally overlapping manner (i.e., the processes may be performed in parallel).

Further, in object detection system 200 in the present embodiment, the generation of target object information and the tracking of target objects are performed inside of object detection system 200. It is thus possible to largely compress the data amount of information to be outputted to external device 5, compared to the case where the range image is outputted to external device 5, and the generation of target object information and the tracking of target objects are performed by external device 5. Such reduction in the amount of data to be outputted can achieve an increase in the processing speed.

Note that when at least one of the items of target object information that correspond to the range segments satisfies a predetermined condition, target object information generator 102 stops causing such target object information to be further generated or causes storage 103 to stop storing such target object information. Alternatively, outputter 105 stops outputting such target object information. For example, target object information generator 102 performs pattern matching of the outer shapes of the detected target object and a pattern that represents a human shape to determine whether such detected target object is a person. When determining that the target object is not a person, target object information generator 102 determines that such target object information is not important and stops causing the target object information to be further generated or causes storage 103 to stop storing the target object information. Alternatively, outputter 105 stops outputting such target object information. With this, it is possible to achieve an object detection system that generates detailed target object information, with a detection target limited to a person.

As described above, object detection system 200 includes: light emitter 1 that emits light; optical sensor 2 that receives reflected light that is the light reflected in a distance-measurable area in a target space; controller 101a that controls light emitter 1 and optical sensor 2; and signal processor 101b that processes information represented by an electric signal generated in optical sensor 2. Here, controller 101a controls light emitter 1 and optical sensor 2 to cause each of range segment signals to be outputted from optical sensor 2 for a corresponding one of range segments into which the distance-measurable area is segmented, the range segment signal being a signal from a pixel that receives the light among a plurality of pixels included in optical sensor 2. Signal processor 101b includes: target object information generator 102 that includes a plurality of generators (first generator 102a through fifth generator 102e) capable of operating in parallel and generates items of target object information indicating features of target objects detected in the range segments by optical sensor 2, based on the range segment signals outputted from optical sensor 2; storage 103 that stores the items of target object information that are generated by target object information generator 102 and correspond to the range segments; and outputter 105 that outputs the items of target object information that correspond to the range segments. Target object information generator 102 compares, for each of the range segments, a past one of the items of target object information stored in storage 103 with a feature of a current one of the target objects detected by optical sensor 2 to generate a corresponding one of the items of target object information.

In this configuration, target object information generator 102 includes a plurality of generators (first generator 102a through fifth generator 102e) capable of operating in parallel and generates items of target object information indicating the features of target objects detected by optical sensor 2 in the corresponding range segments. This achieves object detection system 200 capable of high-speed object detection.

Object detection system 200 further includes: composite image generator 104 that generates a composite image from the range segment signals that are outputted from optical sensor 2 and correspond to the range segments. Here, outputter 105 outputs the composite image generated by composite image generator 104. With this, it is possible to obtain not only information relating to each of the range segments (i.e., target object information), but also information relating to the entirety of the range segments (i.e., composite image).

Also, storage 103 stores a reference image that corresponds to at least one of the range segments, and target object information generator 102 compares the reference image with a corresponding one of the range segment signals relating to the at least one of the range segments that corresponds to the reference image stored in storage 103 to generate a corresponding one of the items of target object information. In this configuration, target object information is generated that indicates the same or a different point from that of the reference image. As such, the use of a past image as the reference image makes it possible, for example, to promptly know only a point that includes a change.

Also, target object information generator 102 corrects the items of target object information, using the composite image. In this configuration, the items of target object information that correspond to the range segments are corrected, using the composite image that includes information about the entirety of the range segments. This increases the accuracy of the items of target object information that correspond to the range segments. For example, the accuracy of the central coordinates of a target object to be detected is increased.

Also, target object information generator 102 corrects the items of target object information, using the range segment signals of the range segments. In this configuration, the items of target object information that correspond to the range segments are corrected, using the range segment signals of the range segments. This increases the accuracy of target object information of a target object that has a three-dimensional shape and is present across a plurality of range segments. For example, the accuracy of the depth range of a target object having a three-dimensional shape is increased. Target object information generator 102 generates target object position information relating to a position of the current one of the target objects in a three-dimensional space, using the range segment signals of the range segments, and calculates a moving speed of the current one of the target objects, using target object position information of a past one of the target objects that is same as the current one of the target objects, With this, it is possible to obtain the moving speed of a target object in a three-dimensional space.

Also, target object information generator 102 approximates, by a curve, the past movement trajectory of the target object that is the same as the current target object, thereby calculating the moving speed of the target object. This enables a highly accurate calculation of the moving speed of a target object, compared to straight-line approximation.

Also, target object information generator 102 generates, from the moving speed, predicted position 81 of a target object in the future as target object information. With this, it is possible to know beforehand predicted position 81 of the target object in the future.

Also, controller 101a changes control signals to send to light emitter 1 and optical sensor 2 to change one of: a total number of the range segments; a range width of each of the range segments; and range segments to be subjected to target object information generation. For example, controller 101a changes the control signals to send to light emitter 1 and optical sensor 2 to cause a range segment signal not to be outputted from optical sensor 2, the range segment signal being one of the range segment signals that corresponds to a range segment, among the range segments, that does not include predicted position 81 of one of the target objects in the future. In this configuration, range segments to be subjected to distance measurement are limited only to important range segments in which a target object is included. This prevents processes from being performed on unnecessary range segments, thereby increasing the entire speed of processing and decreasing power consumption.

Also, when at least one of the items of target object information that correspond to the range segments satisfies a predetermined condition, target object information generator 102 stops further generation of the at least one of the items of target object information or causes storage 103 not to store the at least one of the items of target object information, or outputter 105 stops outputting the at least one of the items of target object information. This prevents additional processes from being performed on unnecessary target object information, thereby increasing the entire speed of processing and decreasing power consumption.

Also, the object detection method according to the foregoing embodiment is an object detection method performed by object detection system 200 including light emitter 1 that emits light and optical sensor 2 that receives reflected light that is the light reflected in a distance-measurable area in a target space. Such object detection method includes: controlling light emitter 1 and optical sensor 2; and processing information represented by an electric signal generated in optical sensor 2. In the controlling, light emitter 1 and optical sensor 2 are controlled to cause each of range segment signals to be outputted from optical sensor 2 for a corresponding one of range segments into which the distance-measurable area is segmented, the range segment signal being a signal from a pixel that receives the light among a plurality of pixels included in optical sensor 2. The processing includes: generating items of target object information indicating features of target objects detected in the range segments by optical sensor 2, based on the range segment signals outputted from optical sensor 2, the generating being performed by a plurality of generators (first generator 102a through fifth generator 102e) capable of operating in parallel; generating a composite image from the range segment signals that are outputted from optical sensor 2 and correspond to the range segments; causing storage 103 to store the items of target object information that are generated in the generating of the items of target object information and correspond to the range segments; and outputting the items of target object information that correspond to the range segments and the composite image. In the generating of the items of target object information, a past one of the items of target object information stored in storage 103 is compared with a feature of a current one of the target objects detected by optical sensor 2, for each of the range segments, to generate a corresponding one of the items of target object information.

With this, in the generating of the items of target object information, a plurality of generators (first generator 102a through fifth generator 102e) capable of operating in parallel generate items of target object information indicating the features of target objects detected by optical sensor 2 in the corresponding range segments, on the basis of the range segment signals outputted from optical sensor 2. This enables the object detection method capable of high-speed object detection.

### [3. Variations]

The foregoing embodiment is only one of various embodiments of the present disclosure. The foregoing embodiment allows for various modifications in accordance with a design, for example, so long as the object of the present disclosure is achieved. Also, the same function as that of information processing system 100 according to the foregoing embodiment may be embodied, for example, as a computer program or a non-transitory recording medium that records the computer program.

A program according to an aspect is a program for causing at least one processor to execute the foregoing information processing method. The program may be recorded on a computer-readable medium to be provided. The following lists variations of the foregoing embodiment. The variations described below may be applicable in combination with the foregoing embodiment where appropriate.

In one variation, in changing the settings stored in controller 101a using a feature of the target object, target object information generator 102 may measure the surroundings of the position of the center of gravity of the target object or predicted position 81 of the destination, using a decreased width of the range segments, without using the method of reducing the number of range segments to be subjected to distance measurement as in the foregoing embodiment.

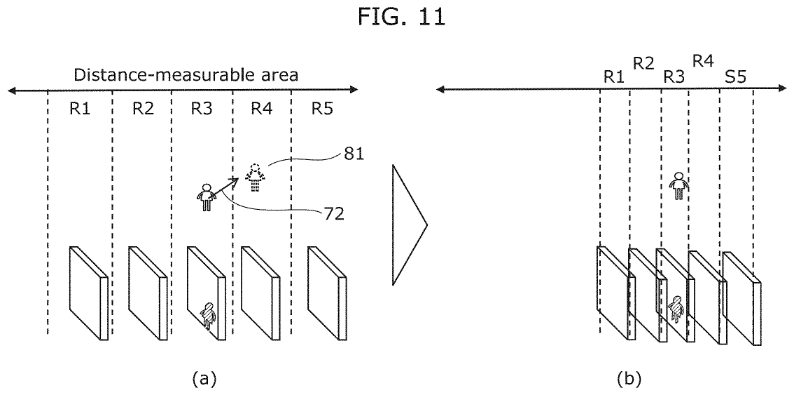

FIG. 11 is a diagram for describing an example of distance measurement performed by target object information generator 102 in a variation of the embodiment. For example, as shown in (a) in FIG. 11, when a person is detected in range segment R3, among range segments R1 through R5, a group of five segments into which three range segments R2 through R4 in the immediately previous frame are segmented may be set as new range segments R1 through R5 in the subsequent frame onward to be subjected to distance measurement. In response to this, controller 101a changes the control signals to send to light emitter 1 and optical sensor 2 to cause the range width of the range segments to be changed. To be more specific, controller 101a changes the control signals to send to light emitter 1 and optical sensor 2 so that the distance-measurable area is reduced to the range width that includes the predicted position of the target object and the range widths of the range segments become shorter. The foregoing variation improves the resolution of the distance measurement, thus resulting in possible increase in the accuracy of target object information.

In one variation, target object information generator 102 may detect target objects in distance-measurable area FR that is extended at regular time intervals. Such variation enables the finding of a target object that appears in a distant position, from a target object already detected.

In one variation, object detection system 200 may generate range segment signals using not the direct TOF as in the foregoing embodiment but the indirect TOF.

In one variation, target object information generator 102 may include an inter-segment information generator. The inter-segment information generator generates target object information for each of different range segment signals. After this, the inter-segment information generator compares items of target object information generated for different range segments to determine whether the items of target object information indicate the same object. When determining that such items of target object information indicate the same object, the inter-segment information generator regenerates target object information for the objects determined to be the same as target object information of a single target object, and outputs the resulting target object information to storage 103 and outputter 105.

Object detection system 200 and the object detection method of the present disclosure have been described above on the basis of the embodiment and its variations, but the present disclosure is not limited to these embodiment and its variations. The scope of the present disclosure also includes: an embodiment achieved by making various modifications to the embodiment and its variations that can be conceived by those skilled in the art without departing from the essence of the present disclosure; and another embodiment achieved by combining some of the elements of the embodiment and its variations.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

Example applications of the present disclosure, as an object detection system that detects an object in each of a plurality of range segments, in particular, capable of high-speed object detection, include: an in-vehicle object detection system aboard an automobile for detecting an obstacle; a monitoring camera that detects an object, a person, and so forth; and a security camera.

1. An object detection system comprising:
a light emitter that emits light;
an optical sensor that receives reflected light that is the light reflected in a distance-measurable area in a target space;
a controller that controls the light emitter and the optical sensor; and
a signal processor that processes information represented by an electric signal generated in the optical sensor,
wherein the controller controls the light emitter and the optical sensor to cause each of range segment signals to be outputted from the optical sensor for a corresponding one of range segments into which the distance-measurable area is segmented, the range segment signal being a signal from a pixel that receives the light among a plurality of pixels included in the optical sensor,
the signal processor includes:
a target object information generator that includes a plurality of generators capable of operating in parallel and generates items of target object information indicating features of target objects detected in the range segments by the optical sensor, based on the range segment signals outputted from the optical sensor;
storage that stores the items of target object information that are generated by the target object information generator and correspond to the range segments; and
an outputter that outputs the items of target object information that correspond to the range segments, and
the target object information generator compares, for each of the range segments, a past one of the items of target object information stored in the storage with a feature of a current one of the target objects detected by the optical sensor to generate a corresponding one of the items of target object information.

2. The object detection system according to claim 1, further comprising:
a composite image generator that generates a composite image from the range segment signals that are outputted from the optical sensor and correspond to the range segments,
wherein the outputter outputs the composite mage generated by the composite image generator.

3. The object detection system according to claim 1,
wherein the storage stores a reference image that corresponds to at least one of the range segments, and
the target object information generator compares the reference image with a corresponding one of the range segment signals relating to the at least one of the range segments that corresponds to the reference image stored in the storage to generate a corresponding one of the items of target object information.

4. The object detection system according to claim 2,
wherein the target object information generator corrects the items of target object information, using the composite image.

5. The object detection system according to claim 1,
wherein the target object information generator corrects the items of target object information, using the range segment signals of the range segments.

6. The object detection system according to claim 1,
wherein the target object information generator generates target object position information relating to a position of the current one of the target objects in a three-dimensional space, using the range segment signals of the range segments, and calculates a moving speed of the current one of the target objects, using target object position information of a past one of the target objects that is same as the current one of the target objects.

7. The object detection system according to claim 1,
wherein the controller changes control signals to send to the light emitter and the optical sensor to change one of: a total number of the range segments; a range width of each of the range segments; and range segments to be subjected to target object information generation.

8. The object detection system according to claim 7,
wherein the controller changes the control signals to send to the light emitter and the optical sensor to cause a range segment signal not to be outputted from the optical sensor, the range segment signal being one of the range segment signals that corresponds to a range segment, among the range segments, that does not include a predicted future position of one of the target objects.

9. The object detection system according to claim 7,
wherein the controller changes the control signals to send to the light emitter and the optical sensor to cause the distance-measurable area to be reduced to a range width that includes a predicted future position of one of the target objects and a range width of each of the range segments to be shorter.

10. The object detection system according to claim 1,
wherein when at least one of the items of target object information that correspond to the range segments satisfies a predetermined condition,
the target object information generator stops further generation of the at least one of the items of target object information or causes the storage not to store the at least one of the items of target object information, or
the outputter stops outputting the at least one of the items of target object information.

11. An object detection method performed by an object detection system including a light emitter that emits light and an optical sensor that receives reflected light that is the light reflected in a distance-measurable area in a target space, the object detection method comprising:
controlling the light emitter and the optical sensor; and
processing information represented by an electric signal generated in the optical sensor,
wherein in the controlling, the light emitter and the optical sensor are controlled to cause each of range segment signals to be outputted from the optical sensor for a corresponding one of range segments into which the distance-measurable area is segmented, the range segment signal being a signal from a pixel that receives the light among a plurality of pixels included in the optical sensor,
the processing includes:
generating items of target object information indicating features of target objects detected in the range segments by the optical sensor, based on the range segment signals outputted from the optical sensor, the generating being performed by a plurality of generators capable of operating in parallel;
causing storage to store the items of target object information that are generated in the generating and correspond to the range segments; and
outputting the items of target object information that correspond to the range segments, and
in the generating, a past one of the items of target object information stored in the storage is compared with a feature of a current one of the target objects detected by the optical sensor, for each of the range segments, to generate a corresponding one of the items of target object information.
